(19) United States
(12) Patent Application Publication
(10) Pub. No.: US 2021/0194645 A1
(43) Pub. Date: Jun. 24, 2021

(54) IMPROVED ASSISTED RETRANSMISSION TECHNIQUE FOR CELLULAR COMMUNICATIONS

(71) Applicant: NOKIA TECHNOLOGIES OY, Espoo (FI)

(72) Inventors: Zexian Li, Espoo (FI); Vinh Van Phan, Oulu (FI); Ling Yu, Kauniainen (FI)

(21) Appl. No.: 16/757,341

(22) PCT Filed: Oct. 19, 2017
(86) PCT No.: PCT/FI2017/050727

§ 371 Date: Apr. 17, 2020

(51) Int. Cl. H04L 1/18; H04L 12/26

(52) U.S. Cl. CPC H04L 1/1887; H04L 1/1893; H04L 43/0847

(57) ABSTRACT

This document discloses a solution for assisting transmissions in a wireless network. According to an aspect, a method comprises: monitoring, by a wireless device, a radio resource for a data packet transmitted by a source device to a sink device and capturing the data packet from the radio resource; decoding the data packet by the wireless device; determining, by the wireless device, that the sink device failed in decoding the data packet and that the wireless device is an assisting transmitter for retransmission of the data packet; and upon said determining, determining by the wireless device a radio resource for the retransmission and performing the retransmission of the data packet in the determined radio resource and together with the source device.

### FIELD

The invention relates to performing retransmissions of data packets associated with failed reception and, in particular, to using an assisting device in the retransmission.

### BACKGROUND

Automatic Repeat Request (ARQ) is a widely used process for improving delivery of data packets between a source device and a sink device. In case the sink device fails in decoding a data packet received from the source device, the sink device indicates the failed transmission to the source device. Upon detecting that the sink device has not acknowledged successful reception of the data packet, a retransmission of the data packet may be performed until the data packet is correctly decoded at the sink device.

### BRIEF DESCRIPTION OF THE INVENTION

The invention is defined by the subject-matter of the independent claims. Embodiments are defined in the dependent claims.

### LIST OF DRAWINGS

In the following, the invention will be described in greater detail with reference to the embodiments and the accompanying drawings, in which

FIG. 1 illustrates a wireless access network to which embodiments of the invention may be applied;

FIGS. 2 and 3 illustrate flow diagrams of processes for carrying out a retransmission procedure according to some embodiments of the invention;

FIG. 4 illustrates a signaling diagram of a procedure for handling retransmissions of a data packet according to an embodiment of the invention;

FIGS. 5 and 6 illustrate modifications to the embodiment of FIG. 4;

FIG. 7 illustrates a flow diagram of an embodiment for determining whether or not a device operates as an assisting transmitter; and

FIGS. 8 and 9 illustrate block diagrams of apparatuses according to some embodiments of the invention.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system.

The embodiments are not, however, restricted to the system given as an example but a person skilled in the art may apply the solution to other communication systems provided with necessary properties. One example of a suitable communications system is the 5G system, as listed above. 5G has been envisaged to use multiple-input-multiple-output (MIMO) multi-antenna transmission techniques, more base stations or nodes than the current network deployments of LTE, by using a so-called small cell concept including macro sites operating in co-operation with smaller local area access nodes and perhaps also employing a variety of radio technologies for better coverage and enhanced data rates. 5G will likely be comprised of more than one radio access technology (RAT), each optimized for certain use cases and/or spectrum. 5G system may also incorporate both cellular (3GPP) and non-cellular (e.g. IEEE) technologies. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, including apart from earlier deployed frequencies below 6 GHz, also higher, that is cmWave and mmWave frequencies, and also being capable of integrating with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as inter-RI operability between cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

FIG. 1 illustrates an example of a communication system to which some embodiments of the invention may be applied. The system may comprise one or more access nodes 100 providing and managing respective cells. The cell may be, e.g., a macro cell, a micro cell, femto, or a pico cell, for example. From another point of view, the cell may define a coverage area or a service area of the access node. The access node 100 may be an evolved Node B (eNB) as in the LTE and LTE-A, an access point of an IEEE 802.11-based network (Wi-Fi or wireless local area network, WLAN), a next generation eNB (gNB), or any other apparatus capable of controlling radio communication and managing radio resources within a cell. For 5G solutions, the implementation may be similar to LTE-A, as described above. The access node may equally be called a base station or a network node. The system may be a wireless communication system composed of a radio access network of access nodes, each controlling a respective cell or cells. The access nodes may provide terminal devices (UEs) 110, 112 with wireless access to other networks such as the Internet. The terminal device 110, 112 may also be called a station or a wireless device.

In the case of multiple access nodes in the communication network, the access nodes may be connected to each other with an interface. LTE specifications call such an interface as X2 interface. In IEEE 802.11 networks, a similar interface is provided between access points. An LTE access node and a WLAN access node may be connected, for example via Xw interface. Other wired or wireless communication methods between the access nodes may also be possible. The access nodes may be further connected via another interface to a core network 130 of the cellular communication system. The LTE specifications specify the core network as an evolved packet core (EPC), and the core network may comprise a mobility management entity (MME), and a gateway (GW) node. The MME may handle mobility of terminal devices in a tracking area encompassing a plurality of cells and also handle signalling connections between the terminal devices and the core network 130. The MME may further carry out authentication and integrity protection for terminal devices 110, 112. The gateway node may handle data routing in the core network 130 and to/from the terminal devices. In an embodiment, the gateway node is replaced by a group of gateway nodes, such as in the LTE networks. In the LTE networks, a serving gateway (SGW) node is configured to assign a suitable packet data network gateway (PGW) for the devices 120,122 to serve a data session. The gateway node may connect to other communication networks such as the Internet.

The radio system of FIG. 1 may support Machine Type Communication (MTC). MTC may enable providing service for a large amount of MTC capable devices, such as the at least one terminal device 110, 112. The at least one terminal device 110, 112 may comprise a mobile phone, smart phone, tablet computer, laptop or other devices used for user communication with the radio communication network, such as an MTC network. These devices may provide further functionality compared to the MTC scheme, such as communication link for voice, video and/or data transfer. However, in MTC perspective the at least one terminal device 110, 112 may be understood as a MTC device. It needs to be understood that the at least one terminal device 110, 112 may also comprise another MTC capable device, such as a sensor device providing position, acceleration and/or temperature information to name a few examples. Some embodiments of the invention may thus be applicable to Internet of Things (IoT) systems, e.g. a radio access technology supporting a narrowband IoT (NB-IoT) communication scheme.

FIG. 1 illustrates an infrastructure-based communication scenario with a fixed access node 100 providing a mobile terminal device 110, 112 with radio access. Another perspective in wireless communications involves wireless links between mobile devices. In a context, the devices 110, 112 may be peer devices in the sense that the devices 110, 112 may be end points of a wireless connection and establish a local peer network, a device-to-device (D2D) link, or a sidelink. The D2D and sidelink concept have been developed to use radio resources of a cellular link provided by the access node 100, typically uplink radio resources. For example, a device 110 may have a cellular radio resource connection with the access node 100 and, additionally, a D2D sidelink with the device 112. The D2D or sidelink may be operated concurrently with the cellular link for D2D data or as an auxiliary connection to the access node.

Ultra-reliable, low latency communications (URLLC) is a concept that is a target for the next generation systems. According to an aspect, it means that the development of the next generation wireless networks, such as the 5G system, focuses on reducing latency and improving reliability of communications. Fast and reliable delivery of data packets between a source device and a sink device is one topic in the concept. Sometimes, a data packet cannot be delivered successfully in an initial transmission, and a retransmission method is needed. Automatic repeat request (ARQ) procedure manages the retransmissions. Improvements to the retransmission procedure provide improvements to the URLLC concept.

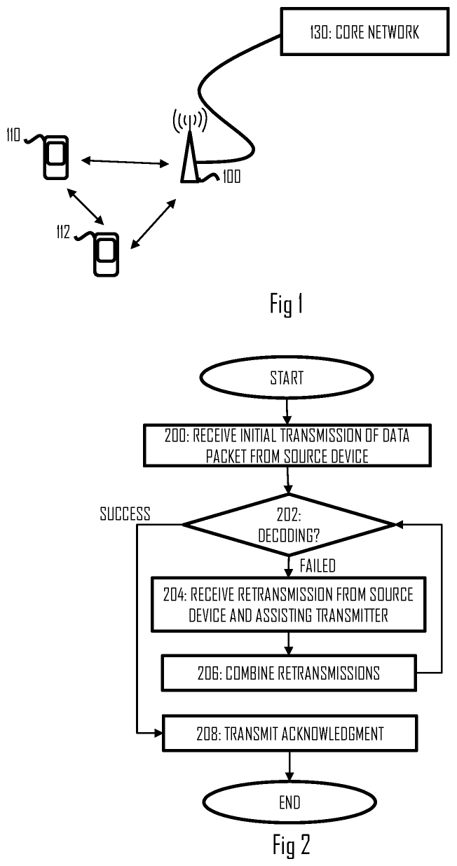

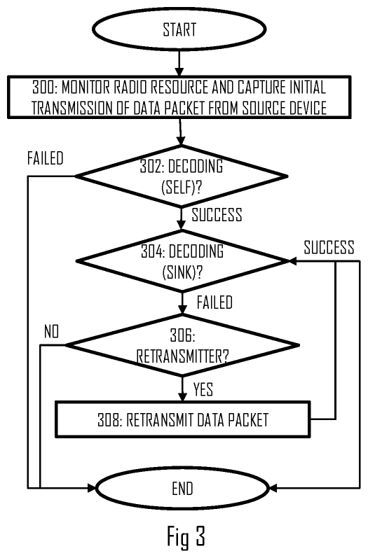

FIGS. 2 and 3 illustrate a retransmission procedure according to some embodiments of the invention. The procedure relates to transmission of one data packet transmitted by a source device to a sink device, but the concept may naturally be employed to the transmission of multiple or all data packets transmitted by the source device. The procedure employs an assisting transmitter to perform a retransmission. FIG. 2 illustrates the procedure from the perspective of operations performed by the sink device, while FIG. 3 illustrates the procedure from the perspective of operations performed by the assisting transmitter.

Referring to FIG. 2, the procedure comprises the following steps performed by the sink device: receiving (block 200) an initial transmission of the data packet from a source device that is an originator of the data packet; determining that decoding of the data packet is not successful (FAILED in block 202); receiving (block 204) a retransmission of the data packet from the source device and an assisting transmitter; combining (block 206) the data packet received from the source device with the data packet received from the assisting transmitter; upon determining that the combined data packet is successfully decoded (SUCCESS in block 202), transmitting (block 208) an acknowledgment to indicate the successful decoding to the source device.

Using combining in the retransmission improves the reliability of the retransmission through the use of combining gain.

Referring to FIG. 3, the procedure comprises the following steps performed by a wireless device: monitoring (block 300) a radio resource for a data packet transmitted by a source device to a sink device and capturing the data packet from the radio resource; decoding the data packet; determining (FAILED in block 304) that the sink device failed in decoding the data packet and (YES in block 306) that the wireless device is an assisting transmitter for retransmission of the data packet; upon said determining, determining a radio resource for the retransmission and performing (block 308) the retransmission of the data packet in the determined radio resource and together with the source device.

In an embodiment, the source device is the access node 100, the sink device is the terminal device 110, and the assisting transmitter and the wireless device is the terminal device 112.

In an embodiment, the sink device is the access node 100, the source device is the terminal device 110, and the assisting transmitter and the wireless device is the terminal device 112.

Let us describe the embodiment described above in connection with FIG. 3 in greater detail. Upon decoding the data packet, the wireless device may determine in block 302 whether the decoding is successful or a failure. Upon failing to decode the data packet, the process may end. Upon successfully decoding the data packet the process may proceed to block 304 where the wireless device determines whether or not the retransmission is needed. Upon detecting that the sink device failed the decoding, the wireless device may determine whether or not to operate as the assisting transmitter in block 306. Upon determining in block 306 that the wireless device is not the assisting transmitter, the process may end. Otherwise, the wireless device may perform the retransmission in the above-described manner.

The order of blocks 302, 304, and 306 may be different from what is illustrated in FIG. 3. For example, the wireless device may initially make the determination of whether or not to operate as the assisting transmitter and, only upon determining to operate as the assisting transmitter, execute block 300. In another embodiment, the order of blocks 304 and 306 are interchanged.

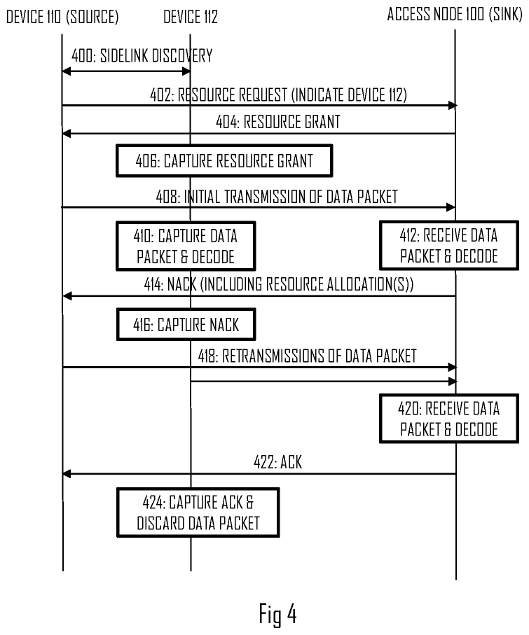

FIG. 4 illustrates a signaling diagram illustrating some embodiments of the procedure described above in connection with FIGS. 2 and 3. The embodiments of FIG. 4 are described with respect to an uplink data packet, but at least some of the embodiments can be applied to a downlink in a straightforward manner. Referring to FIG. 4, the wireless devices 110, 112 may perform a D2D discovery procedure in step 400. The discovery procedure may comprise establishing a pairing between the devices 110, 112. The pairing may comprise establishment of a sidelink between the devices 110, 112 and allocating group identifier to a group comprising or consisting of the devices 110, 112. The group identifier may be called a sidelink radio network temporary identifier (SL_RNTI). The group may comprise more devices in addition to the devices 110, 112. The sidelink may be configured by the access node 100 which may also assign the group identifier to the devices 110, 112 of the sidelink.

In step 402, the device 110 transmits a resource request to the access node 100, e.g. a scheduling request. The resource request is a request for a radio resource to transmit a data packet, and the resource request may comprise an information element indicating the device 112 as the assisting transmitter for potential retransmissions. In an embodiment, the information element comprises a unique identifier of the device 112. In an embodiment, the information element comprises the group identifier of the sidelink, e.g. the SL_RNTI. In some embodiments, the access node 100 may have configured the device 112 as the assisting transmitter before step 402 and, in such embodiments, the information element may be omitted. The device 112 may be aware that it is the assisting transmitter before step 402, e.g. it may be agreed between the devices or configured by the access node 100 in connection with the setup of the sidelink.

Upon receiving the resource request in step 402, the access node may allocate an uplink radio resource to the device 110 and transmit a resource grant message allocating the radio resource to the device. The access node may address the resource grant message to the group identifier and, therefore, both devices 110, 112 may be capable of detecting the grant message and acquiring information on the radio resource allocated for transmission of the data packet. The device 112 captures the grant message in block 406.

In step 408, the device 110 performs the first transmission of the data packet in the allocated radio resource. The device 112 monitors the radio resource, captures the data packet, and decodes the data packet in block 410. Upon successfully decoding the data packet in block, the device 112 may validate its capability of operating as the assisting transmitter for the data packet and start monitoring whether or not the retransmission is needed. Meanwhile, the access node receives the data packet in block 412 and decodes the data packet. Upon successfully decoding the data packet, the access node may transmit a positive acknowledgment message (ACK) to the device 110. However, in the embodiment illustrated in FIG. 4 the decoding fails and the access node transmits a negative acknowledgment message (NACK) in step 414.

As illustrated in FIG. 4, both the sink device (the access node 100 in this embodiment) and the assisting transmitter (the device 112) may receive the same transmission (step 408) of the data packet and decode the data packet. The determination of successful or failed decoding may be carried out by using a cyclic redundancy check (CRC) process.

In an embodiment, the message carrying the NACK in step 414 also comprises an information element allocating a new radio resource for retransmission of the data packet. The device 110 receives the NACK in step 414 and the new resource allocation, and the device 112 also captures the NACK (block 416) and acquires the new resource allocation. In step 418, both devices 110, 112 perform the retransmission of the data packet. In an embodiment, the access node allocates the same time-frequency resource to both devices 110, 112 and the devices perform the retransmission of the data packet in the time-frequency resource synchronously. In such a case, the combining in block 406 is carried out in a radio frequency circuitry of the access node 100, e.g. in the antenna, and baseband signal processing and decoding of the data packet is performed by the access node in block 420 as if it received only one retransmission of the data packet. The retransmissions by the devices 110, 112 may be identical, e.g. have the same transmission format. This concept is sometimes called a single-frequency networking (SFN) concept. In another embodiment, the access node allocates in step 414 different time-frequency resources to the devices 110, 112 for the retransmission of the data packet, and the devices 110, 112 perform the retransmission in separate time-frequency resources. In this embodiment, the access node may combine the data packets either before the decoding or after the decoding, depending on the configuration. The radio frequency circuitry of the access node receives and processes the retransmissions as separate signals.

Upon successfully decoding the data packet in block 420, the access node may transmit the ACK in step 422. The device 112 may again monitor a downlink control channel for the response from the access node to the retransmissions and capture the ACK in block 424. Upon determining that the data packet has been successfully delivered to the sink device, the device 112 may discard the data packet.

It should be appreciated that while FIG. 4 illustrates only a single retransmission, the number of retransmissions may be higher in case the first retransmission fails. Accordingly, steps 414 to 420 may be repeated until the sink device acknowledges correct reception of the data packet.

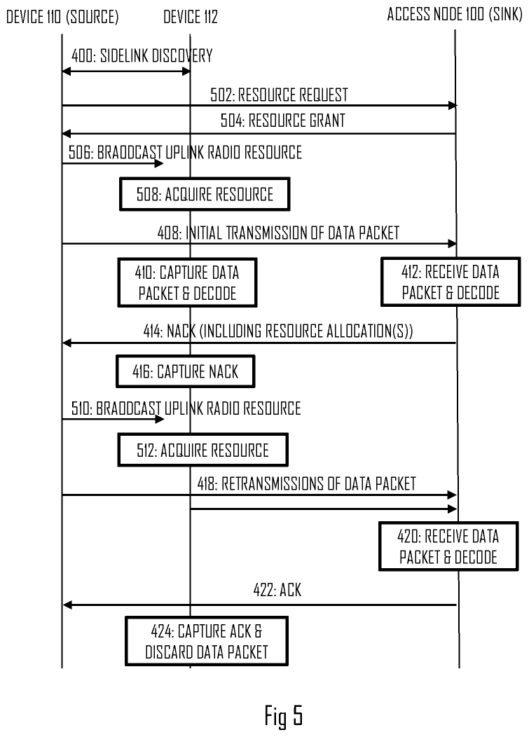

FIG. 5 illustrates another embodiment of the retransmission procedure. The steps having the same reference number as in FIG. 4 represent the same or substantially similar operations as in FIG. 4. In this embodiment, the device 110 transmits the resource request in step 502 without indicating the device 112 as the assisting transmitter. Upon receiving the resource grant from the access node in step 504, the resource grant allocating a radio resource for transmitting the data packet, the device 110 may broadcast a message comprising an information element indicating the radio resource to the device 112 (step 506). As a consequence, the device 112 and other potential assisting transmitters in D2D proximity of the device 110 acquire information (block 508) on the radio resource in which the data packet shall be transmitted. The device 112 then starts monitoring for the radio resource and captures the data packet in block 410 in the above-described manner. Instead of the broadcast message, another type of message may be used to indicate the radio resource to the device(s) of the sidelink(s). The message may be a sidelink scheduling assignment (SL SA) message having a determined format and including the information element. The message may also carry an ARQ process identifier of the data packet to identify the data packet in the ARQ process.

The device 112 may acquire the message indicating the radio resource for the data packet in block 508. Thereafter, the procedure may proceed in the above-described manner until the NACK is received. Upon receiving the NACK and the new radio resource for the retransmission, the device 110 may again transmit or broadcast a message indicating the new radio resource to the potential assisting transmitter(s) (step 510). In this case, the device 112 may monitor for and capture the NACK in block 414, or the device 112 may only wait for the indication of step 510 and omit block 416. Upon acquiring the information that the retransmission is needed and the new radio resource for the retransmission (block 512), the device 112 may perform the retransmission together with the device 110 in step 418 and the process may proceed in the above-described manner.

In an embodiment, instead of carrying out step 510, the device 112 may monitor a downlink control channel and capture a resource grant message allocating a radio resource to the device 110 for the retransmission of the data packet. The device 112 may then perform the retransmission in the same radio resource with the device 110 in the synchronous manner.

The retransmission may be carried out by the devices 110, 112 synchronously in the same time-frequency resource, as described above. In another embodiment, the device 110 indicates in step 510 only the need for retransmission, and the device 112 may transmit a resource request to the access node 100 to request for a radio resource for the retransmission of the data packet. The resource request may comprise a buffer status report. The resource request may have a format and/or an information element indicating to the access node that the resource request is for retransmission of the data packet transmitted by the device 110. The indication may use an identifier of the device 110, the group identifier or a data packet identifier to indicate the retransmission of the data packet. Signaling related to the request and associated grant of the radio resource by the access node may be performed between steps 510 and 418. In this case, the devices acquire different radio resources for the retransmission in step 418.

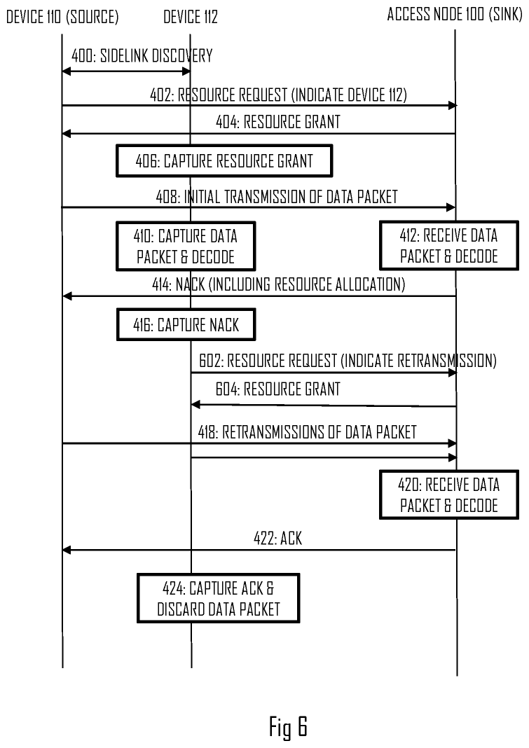

FIG. 6 illustrates such an embodiment where the device 112 requests for a separate radio resource for the retransmission upon determining that the retransmission is needed. In the embodiment of FIG. 6, the device 112 captures the NACK in block 416 and, upon determining that the retransmission is needed and that the device 112 is the assisting transmitter, the device 112 transmits a resource request requesting for the radio resource for the retransmission in step 602. The resource request may indicate that the requested resource is for the retransmission, as described in the previous paragraph. The access node may process the resource request and transmit a resource grant message to the device 112 in step 604, thereby allocating the radio resource to the device 112 for the retransmission of the data packet.

In some embodiments, multiple devices may be configured or determine to operate as the assisting transmitters. For example, in the embodiment of FIG. 5 multiple devices may receive the broadcast in step 506 and capture the initial transmission of the data packet. A potential problem in such situations is excessive amount of help in the retransmission which may cause inefficient spectrum usage. In the embodiment of FIG. 6, the problem may be solved by the access node 100 receiving multiple resource requests (such as the one in step 602) from different assisting transmitters. The access node may grant the requested radio resource only to a subset of the assisting transmitters, e.g. to only one of them. This solution limits the number of assisting transmitters and improves the spectral efficiency.

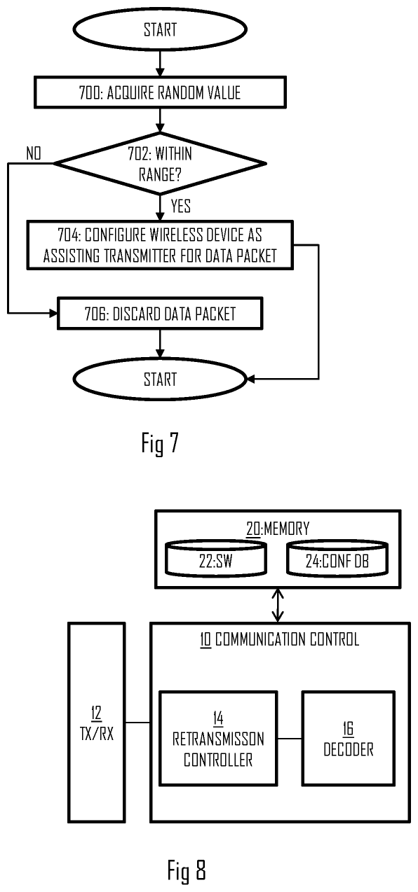

FIG. 7 illustrates another embodiment for controlling the number of assisting retransmitters in a situation where there are no preconfigured assisting transmitters. FIG. 7 illustrates an embodiment of block 306. Referring to FIG. 7, the device executing the process performs a random process biased by a preset probability value defining a probability for the device to operate as the assisting transmitter. In block 700, the device acquires a random value and, in block 702, the device determines whether or not the random value is within a determined range. If the random value is within the determined range, the device may configure itself as the assisting transmitter (block 704). Otherwise, the device may end the process. In an embodiment, the process is executed after receiving the initial transmission of the data packet. Then, upon determining to not operate as the assisting transmitter, the device may discard the data packet (block 706).

In yet another embodiment employing the synchronous transmission, a plurality of assisting transmitters may be configured to carry out the retransmission. This may be carried out without sacrificing the spectral efficiency such that the access node allocates a common time-frequency resource to the assisting transmitters, and the assisting transmitters perform the retransmission of the data packet synchronously in the common time-frequency resource. The source device may perform the retransmission in the same time-frequency resource, or the access node may allocate a dedicated time-frequency resource to the source device. Accordingly the source device and the assisting transmitters perform the retransmission in different radio resources. The access node may allocate a common identifier to the assisting transmitters and allocate the time-frequency resource to the common identifier. Thus, all the assisting transmitters are capable of detecting the resource allocation. In this embodiment, the assisting transmitters of the source device may be preconfigured to provide the common identifier. However, when the initial transmission fails, the access node may schedule the time-frequency resources for the retransmissions to the source device and the common identifier without a separate resource request or upon receiving a resource request only from the source device.

Most embodiments described above relate to uplink transmission of the data packet. The embodiments can be implemented to the downlink in a straightforward manner or with some general modifications to the overall procedure. For example, when the access node is the source device and the device 110 is the sink device, the device 112 may monitor a downlink control channel for a downlink resource allocation to the device 110. Upon detecting the resource allocation, the device 112 may capture a downlink data packet from a radio resource associated with the resource allocation and perform the decoding. Regarding block 304, the device 112 may monitor an uplink channel for an uplink ACK/NACK from the sink device 110. Upon detecting the NACK, the device 112 may perform the retransmission over the sidelink. In another embodiment, instead of monitoring for the uplink ACK/NACK, the device 112 may scan a downlink control channel for an indication from the access node 100 to perform the retransmission. Upon receiving the NACK, the access node 100 may configure the device 112 as the assisting transmitter and allocate a radio resource to the device 112 to perform the retransmission.

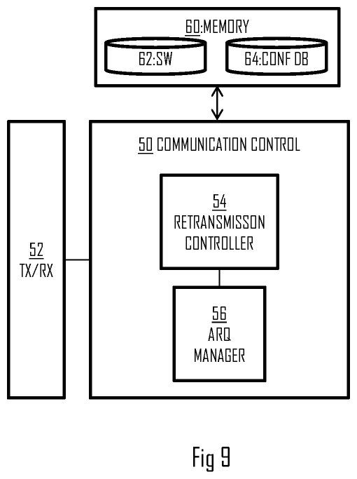

FIGS. 8 and 9 illustrate block diagrams of apparatuses according to some embodiments of the invention. FIG. 8 illustrates the wireless device operating as the assisting transmitter while FIG. 9 illustrates the access node (the sink device). The apparatus of FIG. 8 may be a terminal device or a peer device, or the apparatus may be comprised in any one of such devices. The apparatus may be, for example, a circuitry or a chipset in such a device. The apparatus of FIG. 9 may be the access node or be comprised in such the access node. The apparatus may be, for example, a circuitry or a chipset applicable to the access node. The apparatuses of FIGS. 8 and 9 may be electronic devices comprising electronic circuitries.

Referring to FIG. 8, the apparatus may comprise a communication control circuitry 10 such as at least one processor, and at least one memory 20 including a computer program code (software) 22 wherein the at least one memory and the computer program code (software) are configured, with the at least one processor, to cause the apparatus to carry out any one of the embodiments of the device 112 described above.

The memory 20 may be implemented using any suitable data storage technology, such as semiconductor based memory devices, flash memory, magnetic memory devices and systems, optical memory devices and systems, fixed memory and removable memory. The memory may comprise a configuration database 24 for storing configuration data for use in the transmissions. For example, the configuration database 24 may store information on communication parameters and parameters defining the operation of the apparatus when operating as the assisting transmitter.

The apparatus may further comprise a communication interface (TX/RX) 12 comprising hardware and/or software for realizing communication connectivity according to one or more communication protocols. The communication interface 12 may provide the apparatus with communication capabilities to communicate in a cellular communication system and/or in another wireless network. Depending on whether the apparatus is configured to operate as a terminal device, a peer device, or another device, the communication interface 12 may provide different functions. The communication interface 12 may comprise standard well-known components such as an amplifier, filter, frequency-converter, (de)modulator, and encoder/decoder circuitries and one or more antennas. The communication interface 12 may comprise radio interface components providing the apparatus with radio communication capability in one or more wireless networks.

The communication control circuitry 10 may comprise, as sub-circuitries, a decoder 16 configured to decode received data packets and a retransmission controller 14 managing the retransmissions. The decoder may be configured to carry out the decoding of the received data packet in blocks 302 and 410, for example. The retransmission controller 14 may be configured to carry out configuration of the device as the assisting transmitter according to any one of the above-described embodiments. For example, the retransmission controller 14 may carry out determine, on the basis of the decoding result received from the decoder 16 for a data packet received from the source device, whether or not to configure the communication interface 12 to perform retransmission of the data packet according to any one of the above-described embodiments. The retransmission controller 14 may store the data packet, if it has been successfully decoded, in the memory until the ACK has been detected from the sink device. The retransmission controller may determine a radio resource for the retransmission according to any one of the above-described embodiments.

Referring to FIG. 9, the apparatus may comprise a communication control circuitry 50 such as at least one processor, and at least one memory 60 including a computer program code (software) 62 wherein the at least one memory and the computer program code (software) are configured, with the at least one processor, to cause the apparatus to carry out any one of the embodiments of the network node controlling the authentication, authorization, and/or accounting as described above.

The memory 60 may be implemented using any suitable data storage technology, such as semiconductor based memory devices, flash memory, magnetic memory devices and systems, optical memory devices and systems, fixed memory and removable memory. The memory may comprise a configuration database 64 for storing configuration data. For example, the configuration database 64 may store parameters for configuring the retransmissions of the data packets.

The apparatus may further comprise a communication interface (TX/RX) 52 comprising hardware and/or software for realizing communication connectivity according to one or more communication protocols. The communication interface 52 may provide the apparatus with communication capabilities to communicate in the cellular communication system and/or in another wireless access network. The communication interface may, for example, provide an interface to terminal devices 110, 112 of the wireless access network and another interface towards the core network 130.

Referring to FIG. 9, the communication control circuitry 50 may comprise an ARQ manager 56 configured to manage ARQ processes. The ARQ manager 56 may operate the ARQ processes for both transmitted and received data packets, i.e. the apparatus may operate as the source device or the sink device in the above-described embodiments. The ARQ manager may determine the need for retransmitting a data packet (block 202) and control transmissions of the ACK/NACK messages, when the apparatus operates as the sink device. The ARQ manager 56 may inform a retransmission controller 54 of the need for the retransmission, and the retransmission controller 54 may then configure the retransmissions and allocate associated radio resources according to any one of the above-described embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor (s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 2 to 7 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method comprising:
receiving, by a sink device for a data packet, an initial transmission of the data packet from a source device that is an originator of the data packet;
determining, by the sink device, that decoding of the data packet is not successful;
receiving, by the sink device, a retransmission of the data packet from the source device and from an assisting transmitter;
combining, by the sink device, the data packet received from the source device with the data packet received from the assisting transmitter; and
upon determining that the combined data packet is successfully decoded, transmitting an acknowledgment to indicate the successful decoding to the source device.

2. The method of claim 1, wherein the sink device is an access node for the source device and for the assisting transmitter, and wherein the access node uses a group identifier to address both the source device and the assisting transmitter.

3. The method of claim 2, further comprising receiving by the access node from the source device a resource request for allocating an uplink resource for the data packet, wherein the resource request comprises an information element indicating the assisting transmitter as a retransmitter for the data packet.

4. The method of claim 3, further comprising upon determining that decoding of the data packet was not successful: transmitting a downlink message comprising an allocation of an uplink resource to the group identifier for retransmission of the data packet.

5. The method of claim 1, further comprising by the access node:
after determining that decoding of the data packet was not successful, receiving a plurality of resource requests from a plurality of assisting transmitters, each resource request comprising an information element indicating that the resource request is for retransmission of the data packet;
transmitting a downlink allocation message to a subset of the plurality of assisting transmitters from which the resource request was received, the downlink allocation message comprising an allocation of an uplink resource for retransmission of the data packet.

6. The method of claim 1, wherein the data packet from the source device and the data packet from the assisting transmitter are received in the same time-frequency resource.

7. A method comprising:
monitoring, by a wireless device, a radio resource for a data packet transmitted by a source device to a sink device and capturing the data packet from the radio resource;
decoding the data packet by the wireless device;
determining, by the wireless device, that the sink device failed in decoding the data packet and that the wireless device is an assisting transmitter for retransmission of the data packet;
upon said determining, determining by the wireless device a radio resource for the retransmission and performing the retransmission of the data packet in the determined radio resource and together with the source device.

8. The method of claim 7, wherein the radio resource is an uplink radio resource, the method further comprising by the wireless device:
monitoring a downlink control channel for a resource allocation message addressed to the source device and comprising an information element allocating the uplink radio resource to the source device; and
acquiring information on the uplink radio resource from the resource allocation message.

9. The method of claim 7, wherein the radio resource is an uplink radio resource, the method further comprising by the wireless device:
receiving a broadcast message transmitted by the source device, the broadcast message comprising an information element indicating the uplink radio resource; and
acquiring information on the uplink radio resource from the broadcast message.

10. The method of claim 9, wherein said determining that the wireless device is an assisting transmitter for retransmission of the data packet is carried out by using a random process biased by a preset probability value defining a probability for the wireless device to operate as the assisting transmitter.

11. The method of claim 7, wherein said determining that the sink device failed in decoding the data packet is carried out upon receiving a message from the sink device, the message being addressed to the sink device comprising a negative acknowledgement of the data packet.

12. The method of claim 7, further comprising establishing a direct device-to-device sidelink connection between the wireless device and the source device and, in connection with said establishing, acquiring a group identifier common to the wireless device and the source device.

13. An apparatus, comprising:
at least one processor, and
at least one memory including a computer program code, wherein the at least one memory and the computer program code are configured, with the at least one processor, to cause the apparatus to:
receive, for a data packet, an initial transmission of the data packet from a source device that is an originator of the data packet;
determine that decoding of the data packet is not successful;
receive a retransmission of the data packet from the source device and from an assisting transmitter;
combine the data packet received from the source device with the data packet received from the assisting transmitter;
upon determining that the combined data packet is successfully decoded, cause transmission of an acknowledgment to indicate the successful decoding to the source device.

14. The apparatus of claim 13, wherein the apparatus is suitable for an access node serving the source device and the assisting transmitter, and wherein the at least one memory and the computer program code are configured, with the at least one processor, to cause the apparatus to use a group identifier to address both the source device and the assisting transmitter.

15. The apparatus of claim 14, wherein the at least one memory and the computer program code are configured, with the at least one processor, to cause the apparatus to receive from the source device a resource request for allocating an uplink resource for the data packet, wherein the resource request comprises an information element indicating the assisting transmitter as a retransmitter for the data packet.

16. The apparatus of claim 15, wherein the at least one memory and the computer program code are configured, with the at least one processor, to cause the apparatus to cause, upon determining that decoding of the data packet was not successful, transmission of a downlink message comprising an allocation of an uplink resource to the group identifier for retransmission of the data packet.

17. The apparatus of claim 14, wherein the at least one memory and the computer program code are configured, with the at least one processor, to cause the apparatus to:
after determining that decoding of the data packet was not successful, receive a plurality of resource requests from a plurality of assisting transmitters, each resource request comprising an information element indicating that the resource request is for retransmission of the data packet;
cause transmission of a downlink allocation message to a subset of the plurality of assisting transmitters from which the resource request was received, the downlink allocation message comprising an allocation of an uplink resource for retransmission of the data packet.

18. The apparatus of claim 13, wherein the data packet from the source device and the data packet from the assisting transmitter are received in the same time-frequency resource.

19. An apparatus, comprising:
at least one processor, and
at least one memory including a computer program code, wherein the at least one memory and the computer program code are configured, with the at least one processor, to cause the apparatus to:
monitor a radio resource for a data packet transmitted by a source device to a sink device and capture the data packet from the radio resource;
decode the data packet;
determine that the sink device failed in decoding the data packet and that the apparatus operates as an assisting transmitter for retransmission of the data packet;
upon said determining, determine a radio resource for the retransmission and causing the retransmission of the data packet in the determined radio resource and together with the source device.

20. The apparatus of claim 19, wherein the radio resource is an uplink radio resource, and wherein the at least one memory and the computer program code are configured, with the at least one processor, to cause the apparatus to:
monitor a downlink control channel for a resource allocation message addressed to the source device and comprising an information element allocating the uplink radio resource to the source device; and
acquire information on the uplink radio resource from the resource allocation message.

21. The apparatus of claim 19, wherein the radio resource is an uplink radio resource, and wherein the at least one memory and the computer program code are configured, with the at least one processor, to cause the apparatus to:
receive a broadcast message transmitted by the source device, the broadcast message comprising an information element indicating the uplink radio resource; and
acquire information on the uplink radio resource from the broadcast message.

22. The apparatus of claim 21, wherein the at least one memory and the computer program code are configured, with the at least one processor, to cause the apparatus to perform said determining that the apparatus operates as the assisting transmitter for retransmission of the data packet by using a random process biased by a preset probability value defining a probability for the apparatus to operate as the assisting transmitter.

23. The apparatus of claim 19, wherein the at least one memory and the computer program code are configured, with the at least one processor, to cause the apparatus to perform said determining that the sink device failed in decoding the data packet upon receiving a message from the sink device, the message being addressed to the sink device and comprising a negative acknowledgement of the data packet.

24. The apparatus of claim 19, wherein the at least one memory and the computer program code are configured, with the at least one processor, to cause the apparatus to establish a direct device-to-device sidelink connection between with the source device and, in connection with said establishing, acquire a group identifier common to the apparatus and the source device.

25. An apparatus comprising means for carrying out all the steps of the method according to claim 1.

26. A computer program product readable by a computer and, when executed by the computer, configured to cause the computer to execute a computer process comprising all the steps of the method according to claim 1.
